(19) United States
(12) Patent Application Publication
(10) Pub. No.: US 2009/0101837 A1
(43) Pub. Date: Apr. 23, 2009

(54) MULTILAYER IDENTIFICATION MARKER COMPOSITIONS

(76) Inventors: KOSTANTINOS KOURTAKIS, Media, PA (US); JAMES M. PROBER, Wilmington, DE (US); LARRY EUGENE STEENHOEK, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/874,257

(22) Filed: Oct. 18, 2007

(51) Int. Cl. G01N 21/64; B32B 17/06; B32B 18/00; B32B 23/06; B32B 9/00; B32B 27/06

(52) U.S. Cl. 250/459.1; 428/411.1; 428/426; 428/446; 442/59; 428/537.5; 428/690

(57) ABSTRACT

Multi-layer identification markers, which comprise at least two layers that contain combinations of absorbers and fluorescence emitters, are described. The multi-layer identification markers may have application as security markers and security coatings.

### FIELD OF INVENTION

This invention relates to identification markers. More specifically, the invention provides multi-layer identification marker compositions comprising combinations of absorbers and fluorescence emitters.

### BACKGROUND

Fluorescence is a commonly used method to provide identification markers, which are used to identify articles for various purposes, such as for thwarting counterfeiting or for identifying the source of a material. For example, Ryan et al. (U.S. Pat. No. 3,772,099) describe a phosphor marker for identifying explosives. The phosphor comprises a “spotter” or “locator” phosphor, which is used to locate the marker after an explosive is detonated, and a “coding” material. The coding material is preferably a rare earth metal which produces a narrow band fluorescence emission spectrum when excited with ultra-violet radiation.

Ross et al. (U.S. Pat. Nos. 7,129,506 and 7,256,398) describe an optically detectable security marker comprising a rare earth dopant, such as europium or lanthanum, and a carrier, such as a glass or a plastic. The fluorescent fingerprint of the marker is different from that of the rare earth dopant due to interaction of the carrier and the dopant.

Ricci et al. (U.S. Patent Application Publication No. 2006/0180792) describe a security marker comprising at least one security tag comprising a first dopant incorporated into a host and a second dopant incorporated into a host. The first dopant interacts with its host to luminesce in the visible region of the electromagnetic spectrum at a first wavelength and the second dopant interacts with its host to luminesce only upon excitation at a second wavelength. Preferred dopants are rare earth elements, such as europium and terbium. The host is formed from a glass or a polymeric material.

The uniqueness and therefore the overall identification capacity of fluorescence identification is limited because of the finite width and overlap of the fluorescence emission spectra. Alternative methods are known; however, they are costly and difficult to implement, and therefore limited in their utility.

The problem to be solved therefore is to provide identification markers that have greater identification capacity and flexibility than conventional fluorescence-based markers, and are low cost and easy to implement. The stated problem is addressed herein by the discovery of multi-layer identification marker compositions that comprise combinations of absorbers and fluorescence emitters.

### SUMMARY OF THE INVENTION

In various embodiments, the invention provides multi-layer identification marker compositions comprising combinations of absorbers and fluorescence emitters. Additionally, a method of identifying an object marked with the marker compositions disclosed herein is also provided.

Accordingly, in one embodiment the invention provides a maker composition comprising:
a) a substrate;
b) at least one first layer disposed on the substrate comprising at least one fluorescence emitter wherein the emitter has a fluorescence emission peak at a first wavelength; and
c) at least one second layer disposed on the first layer and comprising at least one second fluorescence emitter and at least one absorber wherein the second fluorescence emitter has a fluorescence emission peak at a second wavelength which is different than said first wavelength and wherein the absorber has an absorption peak that does not correspond to either the first or second wavelength of any of the fluorescence emission peaks.

In another embodiment, the invention provides a marker composition comprising:
a) a substrate;
b) at least one first layer disposed on the substrate comprising at least one fluorescence emitter wherein the emitter has a fluorescence emission peak at a first wavelength;
c) at least one second layer disposed on the first layer comprising at least one absorber; and
d) at least one third layer disposed on the second layer and comprising at least one second fluorescence emitter wherein the second fluorescence emitter has a fluorescence emission peak at a second wavelength which is different than said first wavelength; wherein the absorber has an absorption peak that does not correspond to either the first or second wavelength of any of the fluorescence emission peaks.

In another embodiment, the invention provides a method of identifying a marked object comprising the steps of:
a) providing an object comprising the marker composition as disclosed herein;
b) exciting the marker composition with a first excitation wavelength that excites the at least one first and second fluorescence emitters;
c) detecting the emission from the at least one first and second fluorescence emitters produced by exciting at the first excitation wavelength;
d) exciting the maker composition with a second excitation wavelength that excites the at least one first and second fluorescence emitters;
e) detecting the emission from the at least one first and second fluorescence emitters produced by exciting at the second excitation wavelength; and
f) correlating the detected emission from the at least one first and second fluorescence emitters produced by exciting at the first and second excitation wavelengths with the identity of the marked object wherein the marked object is identified.

### BRIEF DESCRIPTION OF THE FIGURES

The various embodiments of the invention can be more fully understood from the following detailed description and figures, which form a part of this application.

FIG. 1A shows an example of a marker composition comprising two layers; FIG. 1B shows a schematic representation of the fluorescence emission spectra that may be obtained from excitation of the marker at a first wavelength (λ₁) which is not absorbed by the marker; FIG. 1C shows a schematic representation of the fluorescence emission spectra that may be obtained from excitation of the marker at a second wavelength (λ₂) which is absorbed by the marker.

FIG. 2A shows an example of a marker composition comprising three layers; FIG. 2B shows a schematic representation of the fluorescence emission spectra that may be obtained from excitation of the marker at a first wavelength (λ₁) which is not absorbed by the marker; FIG. 2C shows a schematic representation of the fluorescence emission spectra that may be obtained from excitation of the marker at a second wavelength (λ₂) which is absorbed by the marker.

### DETAILED DESCRIPTION OF THE INVENTION

Disclosed herein are novel multi-layer identification marker compositions, which comprise at least two layers that contain combinations of absorbers and fluorescence emitters. These multi-layer marker compositions may have greater identification capacity and flexibility than conventional fluorescence-based markers. The marker compositions disclosed herein may have broad applicability in the security area, for example as security markers and security coatings.

The following definitions are used herein and should be referred to for interpretation of the claims and the specification.

The term “substrate” refers to any suitable material with a substantially flat surface that can serve as a support for the various layers described herein.

The term “fluorescence emitter” refers to any suitable fluorescence substance that absorbs photons of light and re-emits the photons at a different wavelength with a high quantum efficiency to give strong emissions.

The term “absorber” refers to any substance that can be incorporated into a layer and absorbs light of at least one wavelength that is used to excite the marker compositions described herein. Preferably, the absorbance of the layer containing the absorber (which will depend upon the extinction coefficient of the absorbing component, the concentration of the absorbing component in the layer, and the thickness of the layer) is at least about 0.15 (corresponding to a 70% transmittance) but not greater than about 0.70 (corresponding to a 20% transmittance) at one or more of the excitation wavelengths. At wavelengths not substantially absorbed by the absorber, the absorbance of the layer is preferably less than about 0.15 (corresponding to greater than 70% transmittance). The layer containing the absorber does not have an absorption peak that corresponds to the wavelengths of the fluorescence emission peaks of any of the fluorescence emitters in the marker composition.

The term “rare-earth element” refers to the members of the lanthanide series in the periodic table, namely La, Ce, Pr, Nd, Sm, Eu, Gd, Tb, Dy, Ho, Er, Tm, and Yb.

The term “light” refers to radiation in the visible, ultra-violet, and infra-red regions of the electromagnetic spectrum.

The identification marker compositions disclosed herein comprise a substrate having at least two layers disposed thereon. The layers contain at least one absorber and/or at least one fluorescence emitter. The fluorescence emitters are chosen to have a broad absorption peak so that they absorb and are excited by a wide range of excitation wavelengths. The absorbers are chosen to absorb at least a portion of the light of at least one wavelength that is used to excite the marker composition so that an absorber in a layer above a layer comprising a fluorescence emitter will absorb at least a portion of the light passing through the layer, thereby attenuating the fluorescence emission of the emitter in the underlying layer. However, the absorber is chosen not to substantially absorb any of the fluorescence emissions of the emitters. Specifically, the absorbers do not have an absorption peak that corresponds to a fluorescence emission peak of any of the fluorescence emitters in any of the layers. This multi-layer configuration may provide greater identification capacity and flexibility than conventional fluorescence-based markers.

In one embodiment, the identification marker composition comprises a substrate having at least one first layer disposed on the substrate and at least one second layer disposed on the first layer(s). The at least one first layer comprises at least one fluorescence emitter that has a fluorescence emission peak at a first wavelength. The at least one second layer is disposed on top of the first layer(s) and comprises at least one second fluorescence emitter and at least one absorber. The second fluorescence emitter has a fluorescence emission peak at a second wavelength which is different than the first wavelength emitted by the fluorescence emitter in the first layer. The absorber is chosen to have an absorption peak that corresponds to at least one excitation wavelength used to excite the marker composition, but does not correspond to either the first or second wavelength of any of the fluorescence emission peaks.

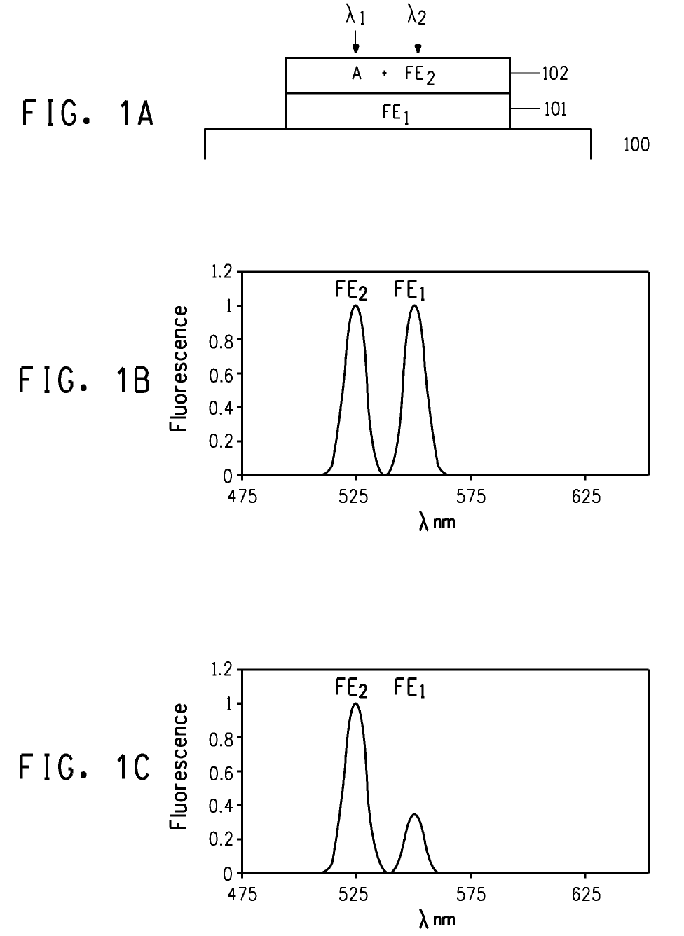

In the simplest form of this embodiment, which is illustrated in FIG. 1A, the identification marker composition comprises a substrate (100) having two layers disposed thereon. The first layer (101) is disposed on the substrate and comprises one fluorescence emitter (FE₁) that has a fluorescence emission peak at a first wavelength. The second layer (102) is disposed on top of the first layer and comprises one second fluorescence emitter (FE₂) and one absorber (A). The second fluorescence emitter has a fluorescence emission peak at a second wavelength which is different than the first wavelength emitted by the fluorescence emitter in the first layer. The absorber is chosen to have an absorption peak that corresponds to one excitation wavelength used to excite the marker composition, but does not correspond to either the first or second wavelength of any of the fluorescence emission peaks.

To identify the multi-layer marker composition, it is excited using a light source at a first excitation wavelength (λ₁). The emitter in the second layer (102) absorbs the light and fluoresces at its fluorescence emission peak wavelength (i.e., the second emission wavelength). When the absorber is selected to absorb light of the second excitation wavelength (λ₂), but not the first excitation wavelength (λ₁), the first excitation wavelength passes through the second layer comprising the absorber and is not attenuated. The emitter in the first layer (101) also absorbs the first excitation wavelength and emits at its fluorescence emission peak wavelength (i.e. the first emission wavelength). Then, the marker composition is excited with a second excitation wavelength (λ₂). Because the absorber is chosen to absorb light of the second excitation wavelength, the excitation intensity of the light is attenuated as it passes through the second layer (102) comprising the absorber. The second fluorescence emitter in the second layer absorbs the light of the second excitation wavelength, which is slightly attenuated by the absorber in the second layer, and fluoresces at its fluorescence emission peak wavelength (i.e., second emission wavelength) with slightly decreased intensity. The emitter in the first layer (101) absorbs the light of the second excitation wavelength and fluoresces at its fluorescence emission peak wavelength (i.e., the first emission wavelength), but the emission intensity is decreased because of the attenuation of the excitation light by the absorber. Therefore, at the first excitation wavelength, the emission of both fluorescence emitters is not attenuated, as depicted by the fluorescence emission spectrum in FIG. 1B and at the second excitation wavelength, the emission of the emitter in the second layer (102) is slightly attenuated and the emission of the emitter in the first layer is attenuated, as depicted by the fluorescence emission spectrum in FIG. 1C. It should be understood that the fluorescence emission spectra shown in FIGS. 1B and 1C are schematic representations that are given only for the purpose of illustration; they do not represent real fluorescence emission data. The emission from the first and second emitters produced by excitation at the first and second wavelengths is detected as described herein below, and the detected fluorescence emissions are correlated with the identity of the marked object. Alternatively, the absorber may be chosen to absorb the first excitation wavelength rather than the second excitation wavelength. In that case the emission of the emitter in the first layer is attenuated at the first excitation wavelength, but not at the second excitation wavelength.

In order to provide greater identification capacity, more that one fluorescence emitter may be used in the first layer, and more than one absorber and more than one emitter may be used in the second layer. Then, the marker composition is excited at a number of different excitation wavelengths, the number corresponding to the number of absorbers used in the second layer.

Additionally, more than two layers may be used. The first layer comprises at least one fluorescence emitter, and the succeeding layers comprise at least one absorber and at least one fluorescence emitter. The absorbers and fluorescence emitters are chosen as described above.

In another embodiment, the identification marker compositions disclosed herein comprise a substrate, at least one first layer, at least one second layer, and at least one third layer disposed on the substrate. In this embodiment, layers comprising at least one fluorescence emitter and layers comprising at least one absorber are stacked in an alternating configuration on the substrate. The fluorescence emitters and absorbers are chosen as described above. In this way, the absorbers in the upper layers attenuate the excitation light having a wavelength which is absorbed by the absorber and thereby attenuates the emission intensity of the fluorescence emitters in all of the underlying layers when that excitation wavelength is used. Specifically, the at least one first layer is disposed on the substrate and comprises at least one fluorescence emitter which has a fluorescence emission peak at a first wavelength. The at least one second layer is disposed on the first layer(s) and comprises at least one absorber. The at least one third layer is disposed on the second layer(s) and comprises at least one second fluorescence emitter which has a fluorescence emission peak at a second wavelength which is different than the first wavelength emitted by the fluorescence emitter in the first layer. The absorber is chosen to have an absorption peak that corresponds to one excitation wavelength used to excite the marker composition, but does not correspond to either the first or second wavelength of any of the fluorescence emission peaks.

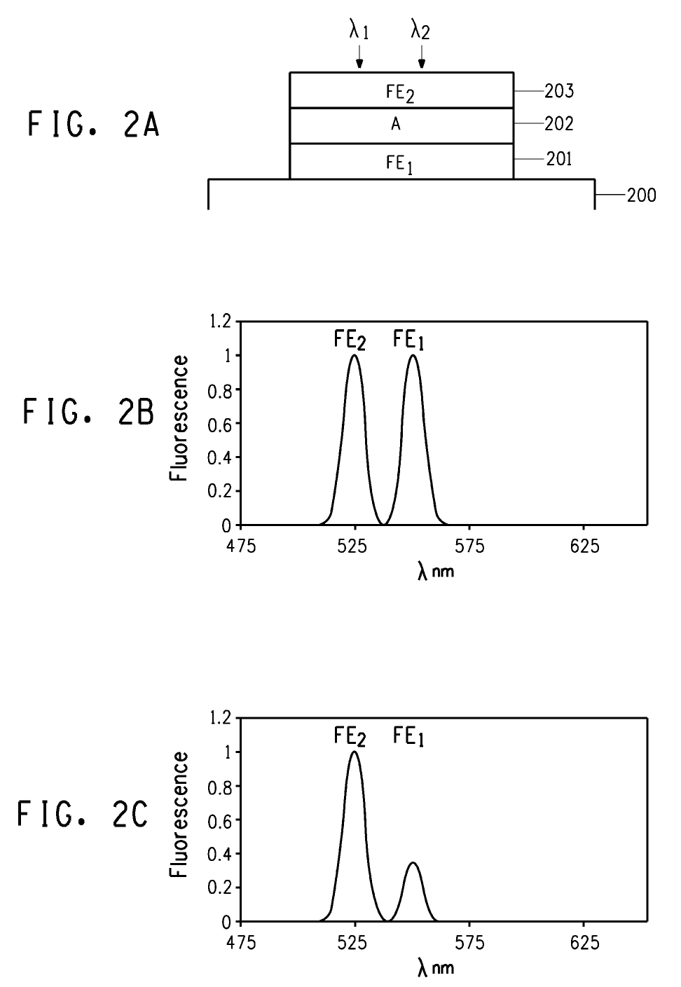

In the simplest form of this embodiment, which is illustrated in FIG. 2A, the identification marker composition comprises a substrate (200) having three layers disposed thereon. The first layer (201) is disposed on the substrate and comprises one fluorescence emitter (FE₁) that has a fluorescence emission at a first wavelength. The second layer (202) is disposed on top of the first layer and comprises one absorber (A). The third layer (203) is disposed on the second layer and comprises one second fluorescence emitter (FE₂) which has a fluorescence emission peak at a second wavelength which is different than the first wavelength emitted by the fluorescence emitter in the first layer. The absorber is chosen to have an absorption peak that corresponds to one excitation wavelength used to excite the marker composition, but does not correspond to either the first or second wavelength of any of the fluorescence emission peaks.

To identify the multi-layer marker composition, it is excited with a light source at a first excitation wavelength (λ₁). The second fluorescence emitter in the third layer (203) absorbs the first excitation wavelength and fluoresces at its fluorescence emission peak wavelength (i.e., the second emission wavelength). If the absorber is chosen to absorb light of the second excitation wavelength (λ₂), but not the first excitation wavelength (λ₁), the fluorescence emitter in the first layer also absorbs the first excitation wavelength and emits at its fluorescence emission peak wavelength (i.e., the first emission wavelength). Then, the composition is excited with a second excitation wavelength (λ₂). The second fluorescence emitter in the third layer (203) absorbs the second excitation wavelength, and fluoresces at its fluorescence emission peak wavelength (i.e., the second emission wavelength). Because the absorber is chosen to absorb light of the second excitation wavelength, the excitation intensity of the light is attenuated as it passes through the second layer (202) comprising the absorber. The fluorescence emitter in the first layer (201) absorbs the second excitation wavelength and fluoresces at its fluorescence emission peak wavelength (i.e., the first emission wavelength), but the emission intensity is decreased because of the attenuation of the excitation light by the absorber. Therefore, at the first excitation wavelength, the emission of both emitters is not attenuated, as depicted by the fluorescence emission spectrum in FIG. 2B, and at the second excitation wavelength the emission of the emitter in the third layer is not attenuated and the emission of the emitter in the first layer is attenuated, as depicted by the fluorescence emission spectrum in FIG. 2C. It should be understood that the fluorescence emission spectra shown in FIGS. 2B and 2C are schematic representations that are given only for the purpose of illustration; they do not represent real fluorescence emission data. The emission from the first and second emitters produced by excitation at the first and second wavelengths is detected as described herein below, and the detected fluorescence emissions are correlated with the identity of the marked object. Alternatively, the absorber may be chosen to absorb the first excitation wavelength rather than the second excitation wavelength. In that case the emission of the emitter in the first layer is attenuated at the first excitation wavelength, but not at the second excitation wavelength.

In order to provide greater identification capacity, more that one fluorescence emitter may be used in the first layer, more than one absorber may be used in the second layer, and more than one fluorescence emitter may be used in the third layer. Then, the multi-layer marker composition is excited at a number of different excitation wavelengths, the number corresponding to the number of absorbers used in the second layer.

Additionally, more than three layers may be used. The first layer comprises at least one fluorescence emitter, the second layer comprises at least one absorber, the third layer comprises at least one second fluorescence emitter, and the subsequent layers follow this pattern of alternating layers. The absorbers and fluorescence emitters are chosen as described above.

The substrate may be any suitable material with a substantially flat surface that can serve as a support for the various layers described above. Suitable examples of substrate materials include, but are not limited to, glasses, fabrics, fibers, polymers, plastics, ceramics, leather goods, metals, papers, and combinations thereof. Additionally, the substrate may be the object to be identified, in which case, the object is coated with the various layers as described herein below.

The absorbers may be any substance that absorbs at least a portion of at least one wavelength that is used to excite the marker compositions described herein, but does not have an absorption peak that corresponds to the wavelengths of the fluorescence emission peaks of any of the fluorescence emitters in the marker composition. Typically, the excitation wavelengths used in the methods disclosed herein are in the visible region, in particular wavelengths from about 350 to about 650 nm. Preferred absorbers include, but are not limited to, oxides of rare earth elements, specifically, lanthanum oxide, cerium oxide, praseodymium oxide, neodymium oxide, promethium oxide, samarium oxide, europium oxide, gadolinium oxide, terbium oxide, dysprosium oxide, holmium oxide, erbium oxide, thulium oxide, ytterbium oxide, and lutetium oxide. In one embodiment, the rare earth oxides are used as particles having a particle size of no greater than about 100 nanometers. Alternatively, various inorganic and organic complexes containing the rare earth ions can be used, provided that in their dried form, they are well dispersed in the absorbing layer and have a particle size of no greater than about 100 nanometers, so that they do not scatter a significant portion of the excitation light.

The fluorescence emitters may be any suitable fluorescence substance that absorbs photons of light and re-emits the photons at a different wavelength with a high quantum efficiency to give strong emissions. Examples include organic fluorescent dyes, inorganic fluorescent materials, and fluorescent proteins. Particularly useful are substances that absorb over a very broad wavelength range and have narrow fluorescence emission peaks. In this way, all of the fluorescence emitters can be excited with the same excitation wavelengths and will fluoresce at their characteristic emission peak wavelengths which can be readily distinguished. Preferred emitters include, but are not limited to, semiconductor nanocrystals comprising cadmium, selenium, tellurium, zinc and mixtures thereof. Such semiconductor nanocrystals are sold under the tradename Qdot® nanocrystals, available from Invitrogen Corp. (Carlsbad, Calif.). Qdot® nanocrystals having different fluorescence emission peaks are available, for example Qdot® 525, Qdot® 565, Qdot® 585, Qdot® 605, Qdot® 655, Qdot® 705, and Qdot® 800, where the number following the Qdot® refers to the wavelength of the fluorescence emission peak. Therefore, the semiconductor nanocrystals may have a fluorescence emission peak at 525, 565, 585, 605, 655, 705, or 800 nanometers.

In one embodiment, the marker composition comprises two layers on a substrate, as described in Example 1 herein below. The first layer comprises a Qdot® nanocrystal having a fluorescence emission peak at 525 nm (i.e., Qdot® 525) and a fluoroelastomer. The second layer comprises a Qdot® nanocrystal having a fluorescence emission peak at 655 nm (i.e., Qdot® 655), praseodymium oxide as the absorber, and a fluoroelastomer binder.

The marker compositions disclosed herein may be prepared using various methods that are known in the art and are not limited by the manner in which they are prepared or the specific form thereof. Broadly, the maker compositions disclosed herein comprise a substrate having at least two layers disposed thereon, as described herein above. The layers may be of any form, for example, the layers may be in the form of a pattern such as printed text or other images, or may be layers of various thicknesses over a specific area. The marker composition may also be a laminated structure that may be attached to the object to be identified using a suitable adhesive. Additionally, the marker composition may comprise the surface of the object to be identified as the substrate with the two or more layers disposed thereon. While it is anticipated that the marker compositions of the invention will find greatest utility in the area of security markers or anti-counterfeiting, the compositions may be employed for any purpose.

The marker compositions disclosed herein may be prepared by depositing the layers on the surface of the substrate using any process that permits deposition of layers from about 1 micron to about 100 microns in thickness. Suitable methods include, but are not limited to, spray coating, inkjet printing, bar coating, slot dye coating, spin coating, dip coating, gravure coating, and microgravure coating. Preferably, the layers comprising the absorber(s) and the layers comprising the fluorescence emitter(s) have an absorbance (i.e., the extinction coefficient times the thickness of the layer, times the concentration of the absorber in that layer) at most excitation wavelengths which is less than about 0.15 so that most of the excitation light can penetrate the layers. At excitation wavelengths which are absorbed by the absorber, the absorbance of the layer comprising the absorber will be preferably at least about 0.15, but not greater than about 0.70 so that the light will be attenuated but can still excite the emission of fluorescent emitters in the layers below.

Numerous chemical formulations are known in the art for preparing inks, paints, and other coating compositions. Such compositions may be used to produce the layers comprising the absorber(s) and/or fluorescence emitter(s) that are deposited on the substrate. Typically, for deposition of the layers on the substrate, the emitters and the absorbers are dispersed in a carrier matrix, also referred to herein as a binder which may comprise a liquid, a polymer, or both. In one embodiment, the polymer may be a photocurable polymer such as an acrylate, an elastomer, or a fluoroelastomer.

Suitable liquids for use in the carrier matrix include, but are not limited to, water, alkanes such as hexane; alcohols; aldehydes; ketones; ethers, such as dipropylene glycol monomethyl ether; esters, such as ethyl acetate, propyl acetate, or dipropylene glycol monomethyl ether acetate; nitrites, amides, aromatics such as toluene; and mixtures thereof. Water and alcohols are preferred. In one embodiment, methanol, ethanol, propanols, butanols, or mixtures thereof are employed. In another embodiment, water is employed. In a further embodiment, a mixture of alcohol and water is used as the carrier liquid.

In one embodiment, the absorber is present in the carrier matrix at a concentration of about 1% to about 50% by weight relative to the total weight of the composition. If more than one absorber is used in the layer, the total concentration of the absorbers in the carrier matrix is about 1% to about 50% by weight relative to the total weight of the composition.

In one embodiment, the fluorescence emitter is present in the carrier matrix at a concentration of about 0.01% to about 50% by weight relative to the total weight of the composition. If more than one emitter is used in the layer, the total concentration of the emitters in the carrier matrix is about 0.01% to about 50% by weight relative to the total weight of the composition.

In embodiments wherein the absorber(s) and the fluorescence emitter(s) are used in the same layer, the total concentration of absorbers present in the carrier matrix is about 1% to about 50% and the total concentration of the fluorescence emitter(s) in the carrier matrix is about 0.01% to about 50% by weight relative to the total weight of the composition.

The optimum concentration of absorbers and emitters for any particular application may be readily determined by one skilled in the art using routine experimentation.

The layers may also comprise additional ingredients such as electrolytes, humectants, defoamers, and the like. The ingredients are chosen so that they do not absorb either the excitation wavelengths used to excite the marker composition or the fluorescence emission wavelengths of the emitters. These additives may be incorporated into the chemical formulation used to produce the layers.

The chemical formulations comprising the absorber(s) and/or fluorescence emitter(s), which are used to prepare the layers on the substrate to produce the marker composition, may be prepared using methods known in the art. For example, the absorber(s) and or emitter(s) may be dispersed in a carrier liquid using a media mill, sand mill, high speed disperser, mulling plates, or other means known in the art. It is important that the absorber particles are small (i.e., no greater than about 100 nanometers), and are well dispersed in the layer so that they do not aggregate into larger particles that can scatter a significant portion of the excitation light, as noted above.

In another embodiment, the invention provides a method of identifying a marked object comprising a marker composition as disclosed herein. In the method, the marker composition is excited with a first excitation wavelength that excites the at least one first and second fluorescence emitters. The light source used to provide the excitation wavelengths may be any source capable of providing wavelengths in the range of about 350 to about 650 nm. Suitable light sources include, but are not limited to, continuous light sources used in conjunction with a wavelength selection device such as a filter, monochromator, prism, or grating; light emitting diodes; or diode lasers.

The fluorescence emission from the at least one first and second fluorescence emitters produced by the excitation at the first excitation wavelength is detected. The fluorescence emissions may be detected in various ways. For example, the fluorescence emission may be observed visually with the aid of a suitable filter to remove the excitation wavelength. Alternatively, the fluorescence emission may be observed using a microscope equipped with a suitable filter to remove the excitation wavelength. Additionally, the fluorescence emission may be detected using a detection system comprising a scanning monochromator and a detector to obtain an emission spectrum for each of the fluorescence emitters at each excitation wavelength.

The marker composition is then excited with a second excitation wavelength that excites the at least one first and second fluorescence emitters and the fluorescence emissions are detected as described above. The marker composition may be excited with additional excitation wavelengths depending on the number of different absorbers used in the marker composition.

The absorber present in at least one of the layers absorbs at least a portion of either the first excitation wavelength or the second excitation wavelength producing an attenuated emission from the at least one first fluorescence emitter in the at least one first layer at the absorbed wavelength. The observed fluorescence emissions may take various forms depending on the marker composition. For example, where the absorbers and fluorescence emitters are evenly dispersed throughout their respective layers, a change in color of the fluorescence emissions may be observed when the marker composition is excited with different excitation wavelengths. Where the layers comprising the absorbers and/or the fluorescence emitters are in the form of a pattern such as printed text or other images, various spatial patterns may be observed.

The detected emission from the at least one first and second fluorescence emitters produced by exciting at the first and second excitation wavelengths are then correlated with the identity of the marked object.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### General Methods

The meaning of abbreviations used is as follows: “min” means minute(s), “mL” means milliliter(s), “nm” means nanometer(s), “mm” means millimeter(s), “cm” means centimeter(s), “cm³” means cubic centimeter(s), “m” means meter(s), “μm” means micrometer(s) or micron(s), “g” means gram(s), “μg” means microgram(s), “mg” means milligram(s), “rpm” means revolutions per minute, “wt %” means percent by weight, “vol %” means percent by volume.

### Example 1

### Prophetic

### Marker Composition

The purpose of this prophetic Example is to describe how to prepare a two layer marker composition. The first layer comprises a fluoroelastomer and Qdot® 525. The second layer comprises Pr₂O₃, Qdot® 655 and a fluoroelastomer binder.

### Preparation of Layer 1

A mixture comprising fluoroelastomer is formed by combining 45 g of a 10 wt % solution of Viton® fluoroelastomer GF200S (E.I. du Pont de Nemours and Co., Wilmington, Del.; dry density 1.8 g/cm³) in propyl acetate with 0.45 g benzoyl peroxide (dry density 1.33 g/cm³), and 0.45 g of Sartomer SR533 (Sartomer Co., Exton, Pa.; dry density 1.16 g/cm³) in 60.14 g of propyl acetate. Then, Qdot® 525 nanocrystals (8.94 g; Invitrogen Corp., Carlsbad Calif.) is added to the mixture at room temperature to form an uncured composition.

A 40.6 cm by 10.2 cm strip of antistatic treated, acrylate hard-coated triacetyl cellulose film is coated with the uncured composition using a microgravure coater (Yasui-Seiki Co. Ltd., Tokyo, Japan, microgravure coating apparatus as described in U.S. Pat. No. 4,791,881). The microgravure coating apparatus includes a doctor blade and a Yasui-Seiki Co. gravure roll #80 (80 lines/inch, 1.5 to 3.5 m wet thickness range) having a roll diameter of 20 mm. Coating is carried out using a gravure roll revolution of 6.0 rpm and a transporting line speed of 0.5 m/min.

The resulting coated film is cut into 10.2 cm by 12.7 cm sections and cured by heating for 20 min at 120° C. under a nitrogen atmosphere. The cured coating is expected to have a thickness of about 1 micron.

### Preparation of Layer 2

The second layer is prepared using the same procedure as described for the first layer, except for the following differences.

Qdot® 655 nanocrystals (4.94 g; Invitrogen Corp.) and 8 g of praseodymium oxide (particle size no greater than 100 nm) are added to the mixture comprising the fluoroelastomer at room temperature to form an uncured composition. The praseodymium oxide is well dispersed in the coating solution, and is added as a preformed colloid (20 wt %) dispersed in methyl ketone. No additional propyl acetate is added to the uncured coating composition, which contains approximately 21 wt % solids.

The second layer is coated on the first layer using a microgravure coating process. A #25 microgravure roller is used for this process to produce approximately a 50-80 μm wet coating or approximately 10-16 μm dry coating. The film is cured by heating in an inert nitrogen atmosphere for approximately 30 min at 120° C. The process is repeated five time to produce a layer thickness of approximately 50 μm or greater. The final wt % of praseodymium oxide in the dried coating is approximately 46 wt % and the praseodymium oxide is well dispersed (i.e. non-agglomerated or with agglomerate sizes less than about 200 nm) in the film.

### Example 2

### Prophetic

### Method of Identifying a Marked Object

The purpose of this Example is to describe how to identify an object comprising the marker composition described in Example 1.

The marker composition described in Example 1 is attached to the object to be identified. The marker composition is excited using a first excitation wavelength of 500 nm, which is not substantially absorbed by the praseodymium oxide absorber, using a continuous light source in combination with a suitable filter, and the fluorescence emission from the Qdot® fluorescence emitters is detected visually using a filter to remove the excitation wavelength. The marker composition is then excited using a second excitation wavelength of 445 nm, which is absorbed by the praseodymium oxide absorber in the second layer, and the fluorescence emission from the Qdot® fluorescence emitters is detected visually using a filter to remove the excitation wavelength. The change in color that is observed upon changing from the first excitation wavelength to the second excitation wavelength is correlated with the identity of the marked object.

What is claimed is:

1. A marker composition comprising:
a) a substrate;
b) at least one first layer disposed on the substrate comprising at least one fluorescence emitter wherein the emitter has a fluorescence emission peak at a first wavelength; and
c) at least one second layer disposed on the first layer and comprising at least one second fluorescence emitter and at least one absorber wherein the second fluorescence emitter has a fluorescence emission peak at a second wavelength which is different than said first wavelength and wherein the absorber has an absorption peak that does not correspond to either the first or second wavelength of any of the fluorescence emission peaks.

2. A marker composition comprising:
a) a substrate;
b) at least one first layer disposed on the substrate comprising at least one fluorescence emitter wherein the emitter has a fluorescence emission peak at a first wavelength;
c) at least one second layer disposed on the first layer comprising at least one absorber; and
d) at least one third layer disposed on the second layer and comprising at least one second fluorescence emitter wherein the second fluorescence emitter has a fluorescence emission peak at a second wavelength which is different than said first wavelength; wherein the absorber has an absorption peak that does not correspond to either the first or second wavelength of any of the fluorescence emission peaks.

3. A marker composition according to claim 1 or claim 2 wherein the substrate is comprised of a material selected from the group consisting of glasses, fabrics, fibers, polymers, plastics, ceramics, leather goods, metals, papers, and combinations thereof.

4. A marker composition according to claim 1 or claim 2 wherein the first or second fluorescence emitter is a semiconductor nanocrystal comprising cadmium, selenium, tellurium, zinc and mixtures thereof.

5. The marker composition according to claim 4 wherein the semiconductor nanocrystal has a fluorescence emission peak at 525, 565, 585, 605, 655, 705, or 800 nanometers.

6. A marker composition according to claim 1 or claim 2 wherein the absorber is a rare earth oxide selected from the group consisting of lanthanum oxide, cerium oxide, praseodymium oxide, neodymium oxide, promethium oxide, samarium oxide, europium oxide, gadolinium oxide, terbium oxide, dysprosium oxide, holmium oxide, erbium oxide, thulium oxide, ytterbium oxide, and lutetium oxide.

7. A method of identifying a marked object comprising the steps of:
a) providing an object comprising the marker composition of claim 1 or claim 2;
b) exciting the marker composition with a first excitation wavelength that excites the at least one first and second fluorescence emitters;
c) detecting the emission from the at least one first and second fluorescence emitters produced by exciting at the first excitation wavelength;
d) exciting the maker composition with a second excitation wavelength that excites the at least one first and second fluorescence emitters;
e) detecting the emission from the at least one first and second fluorescence emitters produced by exciting at the second excitation wavelength; and
f) correlating the detected emission from the at least one first and second fluorescence emitters produced by exciting at the first and second excitation wavelengths with the identity of the marked object wherein the marked object is identified.
